(19) United States
(12) Patent Application Publication
(10) Pub. No.: US 2022/0114624 A1
(43) Pub. Date: Apr. 14, 2022

(54) Digital Content Text Processing and Review Techniques

(71) Applicant: Adobe Inc., San Jose, CA (US)

(72) Inventors: Ajay Jain, Ghaziabad (IN); Shagun Kush, Karnal (IN); Sanjeev Tagra, Redmond, WA (US); Sachin Soni, New Delhi (IN); Ryan Timothy Rozich, Austin, TX (US); Jonathan Stephen Roeder, Round Rock, TX (US)

(73) Assignee: Adobe Inc., San Jose, CA (US)

(21) Appl. No.: 17/066,886

(22) Filed: Oct. 9, 2020

(51) Int. Cl. G06Q 30/02; G06Q 10/10; G06F 16/35; G06F 16/9538; G06F 16/48; G06N 7/00; G06F 40/279

(52) U.S. Cl. CPC G06Q 30/0282; G06Q 10/10; G06F 16/355; G06Q 30/0185; G06F 16/48; G06N 7/005; G06F 40/279; G06F 16/9538

(57) ABSTRACT

Digital content text processing techniques are described. In one example, a text corpus is extracted from digital content and text corpus keywords are identified that are included in the text corpus. A plurality of clusters is formed based on the text corpus keywords. Cluster scores are generated for reviews that define a probability the review belongs to a respective cluster, e.g., based on review keywords extracted from the reviews. Sentiment values and sentiment weights are also generated. The sentiment values describe a sentiment that each of the reviews exhibits towards a respective cluster, e.g., a type of sentiment such as positive, neutral, or negative. The sentiment weights describe an amount of weight to be applied for each sentiment with respect to that cluster. The service provider system then generates ranking scores based on the cluster scores and the sentiment scores which are used to control output of the reviews.

### BACKGROUND

Computing devices expose users to an ever-increasing variety and amount of digital content, examples of which streaming digital content (e.g., movies and television shows), digital books, webpages, digital content made available for the purchase of goods and services, and so forth. Accordingly, navigation through digital content using conventional techniques is typically daunting and inefficient both to the users of the computing devices and involves inefficient consumption of computational and network resources of the computing devices in order to provide this digital content.

Techniques have been developed to address these challenges by collecting additional information that describes a subject of the digital content to aide users in making decisions regarding which items of digital content to consume. One example of this is collecting reviews of the subject of the digital content that are user generated. For example, the digital content may involve streaming of a digital movie and the reviews describe the experience of different users in watching the digital movie. Other examples include digital content that describes a good or service and the reviews describe the user experience with the good or service described by the digital content.

However, these techniques also suffer from the challenges involved with the digital content, itself. For example, hundreds and even thousands of reviews may be generated each item of digital content and therefore the number of reviews is even greater than the number of items of digital content that are available to users of computing devices. As such, it is not realistically possible for the users of the computing devices in real world scenarios to navigate through this multitude of reviews to gain an accurate understanding of a subject of the digital content. Users of computing devices, for instance, are challenged with balancing an amount of time involved to parse the reviews with a likelihood that the users may not be exposed to relevant information contained in the reviews. As such, conventional techniques involving the collection and dissemination of reviews result in inefficient user navigation and consumption of network and computational resources involved in communicating, displaying, and interacting with hundreds and even thousands of these reviews.

### SUMMARY

Digital content text processing techniques are described that are implemented by computing devices to overcome conventional challenges in providing reviews by service provider systems. In one example, a text corpus is extracted by a service provider system from digital content and text corpus keywords are identified that are included in the text corpus. A plurality of clusters is formed by the service provider system based on the text corpus keywords. Cluster scores are generated by the service provider system for each of the reviews that define a probability the review belongs to a respective cluster, e.g., based on review keywords extracted from the reviews. Sentiment values and sentiment weights are also generated by the service provider system. The sentiment values describe a sentiment that each of the reviews exhibits towards a respective cluster, e.g., a type of sentiment such as positive, neutral, or negative. The sentiment weights describe an amount of weight to be applied for each sentiment with respect to that cluster. The service provider system then generates ranking scores based on the cluster scores and the sentiment scores which are used to control output of the reviews.

The service provider system also supports functionality to specify an amount of reviews that are disseminated to users of computing devices that is controllable by those computing devices. In one instance, a control is configured to specify relatively greater or lesser amounts of reviews to be output. The service provider system, upon receipt of data describing the user input, then selects a number of reviews based on the indicated amount. In one example, the service provider system selects reviews based on the ranking scores.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ digital content text processing and review techniques described herein.

FIG. 2 depicts an example of output of digital content in a user interface of a computing device of FIG. 1.

FIG. 3 depicts an example system showing operation of a text corpus processing system of FIG. 1 in greater detail as performing text corpus keyword generation.

FIG. 4 is a flow diagram depicting a procedure in an example implementation in which a text corpus is generated from digital content and used to extract text corpus keywords that are to serve as a basis to generate clusters to process reviews.

FIG. 5 depicts an example system showing operation of the review processing system of FIG. 2 in greater detail.

FIG. 6 is a flow diagram depicting a procedure in an example implementation in which text corpus keywords are used to generate clusters that are then used to organize reviews based on cluster membership and sentiment.

FIG. 7 depicts an example system showing ranking of reviews and use of a control to control output of a number of the reviews.

FIG. 8 is a flow diagram depicting a procedure in an example implementation in which a determination is made as to a number of reviews based on user interaction with a control, which are selected and output for viewing in a user interface.

FIG. 9 depicts a procedure in an example implementation of display of a user interface, detection of an input, and output of a number of reviews based on the input.

FIG. 10 illustrates an example system including various components of an example device that can be implemented as any type of computing device as described and/or utilize with reference to FIGS. 1-9 to implement embodiments of the techniques described herein.

### DETAILED DESCRIPTION

### Overview

Conventional techniques used to gain insight into the multitude of digital content made available to users also suffer from numerous challenges in that there is an even greater multitude of information available that describes this digital content. For example, consider digital content that includes a text corpus that describes a subject of the digital content, e.g., a product description of a good or service, a plot of streaming digital content, and so forth. Users are first tasked with navigating to this digital content using a computing device and parsing the text corpus manually to gain insight, which is oftentimes specified by a provider of the digital content.

Therefore, in order to gain additional insights, such as opinions of other users that have interacted with the digital content (i.e., a subject of the digital content) that do not have a pecuniary interest in providing this digital content, users are also tasked with navigating through reviews collected from these users. A service provider system, for instance, that provides the digital content also collects reviews that are generated by these users through interaction with respective computing devices. The service provider system then manages dissemination of the reviews to users of computing devices that are interested in a subject of associated digital content. However, in real world scenarios this results in hundreds and thousands of reviews for even a single item of digital content, and thus are difficult to manually parse by the users and result in inefficient use of computational and network resources to collect and support navigation of these reviews using conventional techniques.

Accordingly, digital content text processing techniques are described that are implemented by computing devices to overcome conventional challenges in providing reviews by service provider systems as well as navigating through the reviews involving digital content by users of computing devices that interact with the system. As a result, efficiency of computational resources of the service provider system and the computing devices employed by the users is improved through enhanced navigation and refined insight into the reviews as supported by these techniques.

In one example, digital content is received by a service provider system, such as a webpage involving a subject such as a streaming digital movie or television program, digital book, a good or service offered for sale, and so forth. A text corpus processing system of the service provider system extracts a text corpus from the digital content, e.g., from a markup language associated with the digital content, through optical character recognition of digital images included as part of the digital content, or any other technique usable to detect text. The text corpus processing system identifies text corpus keywords included in the text corpus, e.g., based on term frequency, entity recognition, and so on. The text corpus keywords are then output by the text corpus processing system to a review processing system of the service provider system.

The review processing system is configured to collect, manage, and disseminate reviews associated with a subject of the digital content, e.g., as part of the digital content itself, what is described by the digital content, and so forth. To do so, the review processing system collects reviews from client devices of users via a network, e.g., input via a user interface exposed over a network, email, electronic messages, and so forth.

The review processing system extracts review keywords from the reviews, e.g., based on term frequency, entity recognition, and so on as performed for the text corpus keywords above. A plurality of clusters is also formed by the review processing system based on the text corpus keywords, e.g., using a variety of different clustering techniques such as fuzzy c-means (FCM). Thus, each of the clusters is defined based on a respective text corpus keyword extracted from the text corpus, e.g., a product description on a webpage. Cluster scores are then generated by the review processing system for each of the reviews that define a probability (i.e., a degree to which) the review belongs to a respective cluster, and more particularly corresponds to a text corpus keyword that is used to define the cluster.

The review processing system also generates sentiment values and sentiment weights. The sentiment values describe a sentiment that each of the reviews exhibits towards a respective cluster, e.g., a type of sentiment such as positive, neutral, or negative. For example, a cluster “camera lens” for a subject “mobile phone” may include reviews that have positive, neutral, or negative sentiment towards the camera lens. The sentiment weights describe an amount of weight to be applied for each sentiment with respect to that cluster. This is definable in a variety of ways, an example of which includes based on a proportion of the reviews that are assigned to the cluster that correspond to the type of sentiment, with respect of a number of reviews overall for the subject, and so on.

The review processing system then generates ranking scores based on the cluster scores and the sentiment scores. This is performed by multiplying the cluster scores by the sentiment weights based on a respective sentiment value (e.g., type of sentiment) exhibited by the respective review, which are then aggregated together. In an implementation, the review processing system is also configured to take additional features into account. Examples of these features include presence and number of review keywords extracted from the reviews, date of review, presence and number of digital images included in the review, mention of competitor brands, upvotes/likes/comments on the review, verified profile associated with the review, and so on. The ranking scores are then maintained by the review processing system to control which reviews are output by the service provider system.

In one example, the service provider system supports functionality to specify an amount of reviews that are disseminated to users of computing devices that is controllable by those computing devices. Continuing with the example above suppose a user's computing device is used to navigate to digital content (e.g., a webpage) describing a good for sale. A control is included on the webpage that support user interaction to specify an amount (e.g., a relative amount) of reviews to be output in a user interface. The control, for instance, is configurable as a slide to specify relatively greater or lesser amounts of reviews to be output. Other instances are also contemplated, such as to specify a particular number, use of radial buttons, gestures, spoken utterances, and so forth.

The service provider system, upon receipt of data describing the user input, then selects a number of reviews based on the indicated amount. In one example, the service provider system selects reviews based on the ranking scores, solely. In another example, the service provider system selects reviews from clusters that collectively have the highest ranked reviews. The service provider system may also take into account the sentiment values and weights, such as to select reviews from within the clusters based on proportions of sentiments exhibited by reviews assigned to those clusters. In this way, the digital content text processing and review techniques described herein overcome the challenges of conventional techniques by support automated curation and dissemination of reviews, which improves both user and computational efficiency as further described in the following sections.

In the following discussion, an example environment is first described that may employ the techniques described herein. Example procedures are also described which may be performed in the example environment as well as other environments. Consequently, performance of the example procedures is not limited to the example environment and the example environment is not limited to performance of the example procedures.

### Example Environment

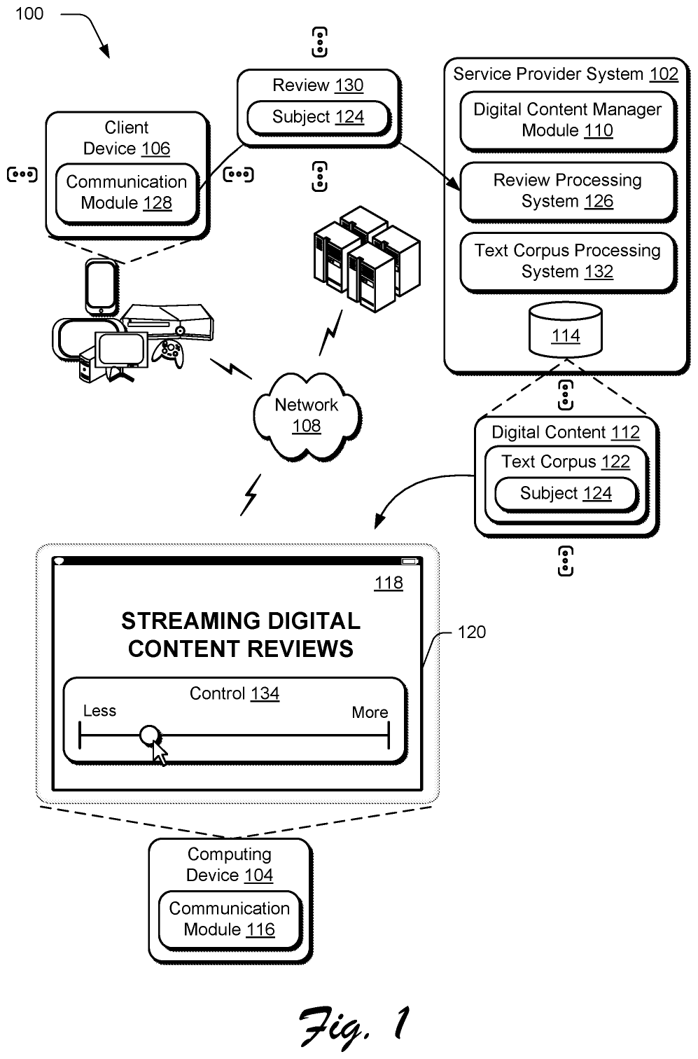

FIG. 1 is an illustration of a digital medium environment 100 in an example implementation that is operable to employ digital content text processing techniques described herein. The illustrated environment 100 includes a service provider system 102, a computing device 104, and a plurality of client devices represented as client device 106 that are communicatively coupled, one to another, via a network 108, e.g., the Internet. Computing devices that implement these entities are configurable in a variety of ways.

A computing device, for instance, is configurable as a desktop computer, a laptop computer, a mobile device (e.g., assuming a handheld configuration such as a tablet or mobile phone as illustrated for computing device 104), and so forth. Thus, a computing device may range from full resource devices with substantial memory and processor resources (e.g., personal computers, game consoles) to a low-resource device with limited memory and/or processing resources (e.g., mobile devices). Additionally, although a single computing device is described and shown in some instances, a computing device is also representative of a plurality of different devices, such as multiple servers utilized by a business to perform operations “over the cloud” as shown for the service provider system 102 and as further described in relation to FIG. 10.

The service provider system 102 includes a digital content manager module 110 that is configured to collect, maintain, and disseminate digital content 112, which is illustrated as stored in a storage device 114. Digital content 112 is configurable in a variety of ways, examples of which include webpages, pages of a user interface, digital movies and television programs, digital songs, digital books, digital audio, digital media, and any other electronic format that is configured to be maintained electronically in a storage device 114 for communication via a network 108. The digital content 112, for instance, is communicated over the network 108 for access by a communication module 116 of the computing device 104, e.g., via a browser, network-enabled application, plugin module, and so on, and display in a user interface 118 rendered by a display device 120. Similar scenarios are also employed for access by the client device 106.

The digital content 112 includes a text corpus 122 that corresponds to a subject 124. In one example, the subject 124 directly involves the digital content 112 itself, e.g., the digital content 112 is a particular digital movie, digital book, etc. and therefore the subject 124 is the digital content 112. In another example, the subject 124 indirectly involves the digital content 112. Continuing with the webpage example above, the webpage describes a subject 124 such as a digital movie, good or service offered for sale, and so on and thus the text corpus 122 includes text describing characteristics of that subject 124.

The service provider system 102 also includes a review processing system 126. As described above, client devices 106, through use of respective communication modules 128, also access digital content 112 via the network 108. The review processing system 126 is thus configured to collect reviews 130 from these client devices 106 that pertain to a subject 124 of the digital content 112. A variety of different techniques are employed by the review processing system 126 to collect these reviews 130, including verified client devices 106 that have interacted with the digital content 112 and/or a subject 124 of the digital content, use of electronic solicitations to generate the reviews 130 about the subject 124, output of an option to provide a review as part of the digital content 112, and so forth.

The review processing system 126 is also configured to manage dissemination of these reviews 130, e.g., to the computing device 104, in a manner that overcomes the challenges of conventional dissemination techniques previously described. For example, conventional review dissemination techniques support an ability to sort reviews based on “top reviews” that have been manually indicated as helpful by other users, recency, filter based on ratings given to the subject, perform searches, view ratings, and so forth. However, each of these conventional techniques requires a user to balance significant amounts of time involving user navigation with the potential of missing a review that provides helpful insight.

Accordingly, the service processing system 102 in the illustrated example includes a text corpus processing system 132 that is configured to extract text corpus keywords from a text corpus 122 of the digital content, e.g., based on term frequency, entity recognition, and so forth. In an instance in which the subject 124 involves a good or service for sale, the text corpus 122 describes characteristics of that good or service. The text corpus keywords are then employed by the review processing system 126 to generate clusters (e.g., using fuzzy c-means clustering), which are used to cluster the reviews 130 based on review keywords extracted from the reviews 130. Cluster scores are generated that define a probability that a respective review 130 corresponds to a respective cluster as further described below.

The review processing system 126 is also configured to generate sentiment values for the different reviews 130 with respect to the clusters. The sentiment values, for instance, describe whether the review 130 exhibits a positive, neutral, or negative sentiment towards respective clusters. Amounts of these sentiments exhibited for the respective clusters are then used to set sentiment weights for the types of sentiments, e.g., based on an overall proportion exhibited for that type of sentiment by reviews assigned to a respective cluster or to the subject overall.

Scoring techniques are also employed by the review processing system 126 to score the reviews 130 based on this clustering. Continuing with the example above, cluster scores define a probability that a respective review 130 belongs to a respective cluster. Other features may also be taken into account along with the cluster scores, such as presence and number of review keywords extracted from the reviews, date of review, presence and number of digital images included in the review, mention of competitor brands, upvotes/likes/comments on the review, verified profile associated with the review, and so on. This combination is referred to as a feature score in this example.

The review processing system 126 then employs the sentiment weights as a coefficient to the feature scores to generate a ranking score for the reviews 130 with respect to each of the clusters. The ranking scores are used by the review processing system 126 to control dissemination of the reviews 130, e.g., to the computing device 104. The review processing system 126, for instance, outputs data for display in the user interface 118 of the computing device 104 to render a control 134. The control 134 supports user interaction to specify an amount (e.g., a relative amount) of reviews to be output in the user interface 118. In the illustrated example, the control 134 is configured as a slider to specify relatively greater or lesser amounts of reviews to be output. Other instances are also contemplated, such as to specify a particular number, use of radial buttons, gestures, spoken utterances, and so forth.

The review processing system 126, upon receipt of data via the network 108 describing the user input, then selects a number of reviews based on the specified amount. In one example, the review processing system 126 selects reviews based on the ranking scores, solely. In another example, the review processing system 126 selects reviews from clusters that collectively have the highest ranked reviews. The review processing system 126 may also take into account the sentiment values and weights, such as to select reviews from within the clusters based on proportions of sentiments exhibited by reviewed assigned to those clusters. In this way, the techniques described herein overcome the challenges of conventional techniques by support automated curation and dissemination of reviews with a greater likelihood of being relevant to the subject 124 of the digital content 112, which improves both user and computational efficiency as further described in the following sections.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Text Corpus Keyword Extraction

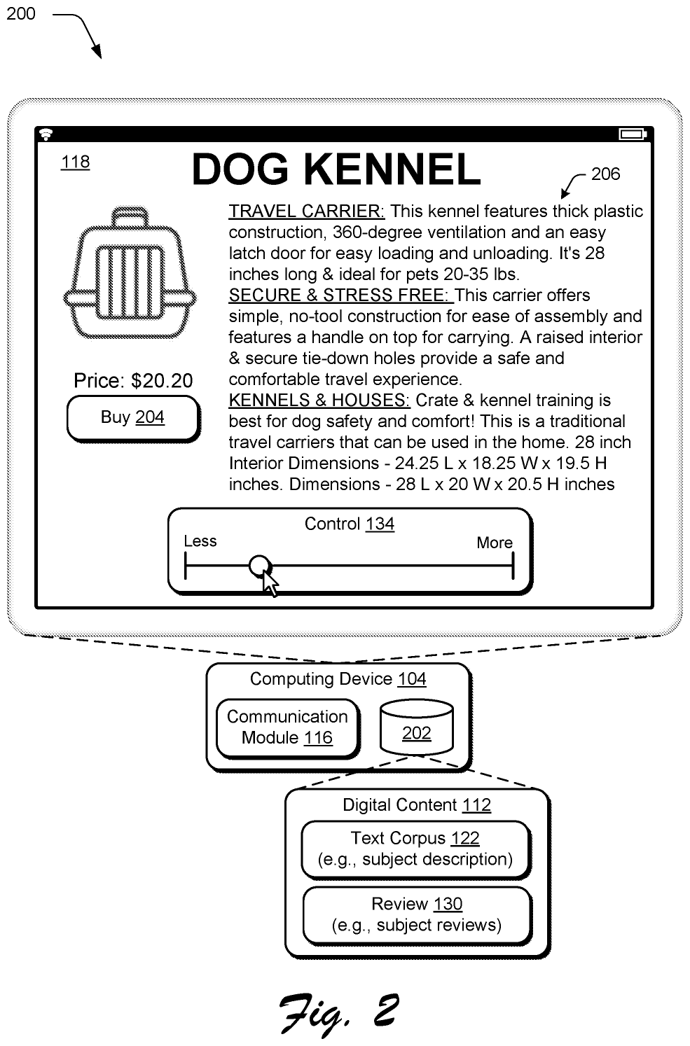

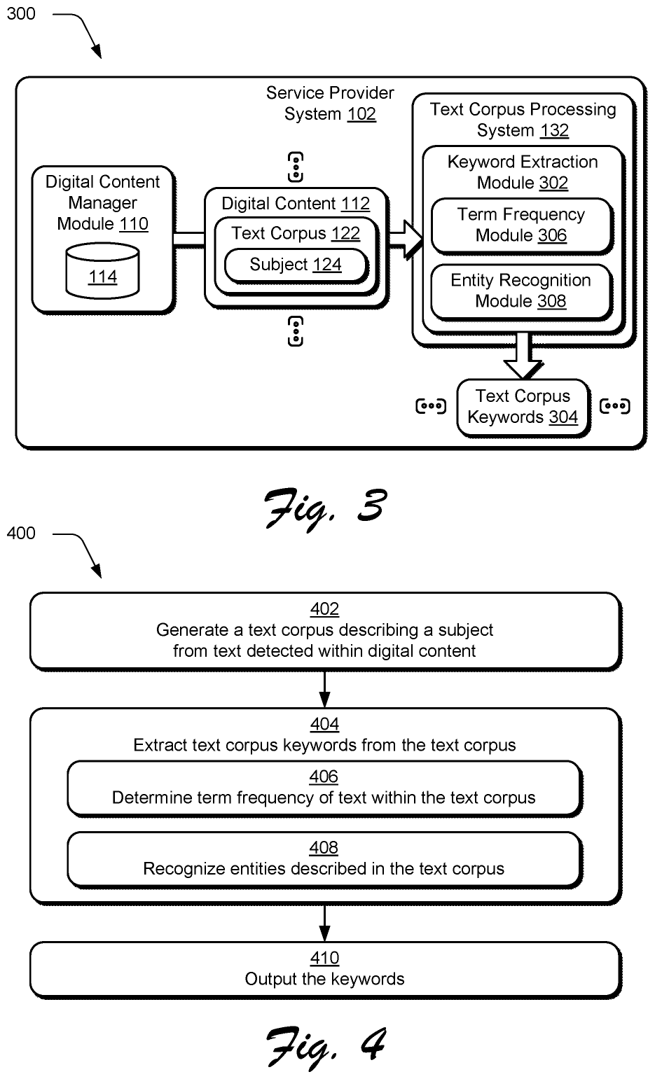

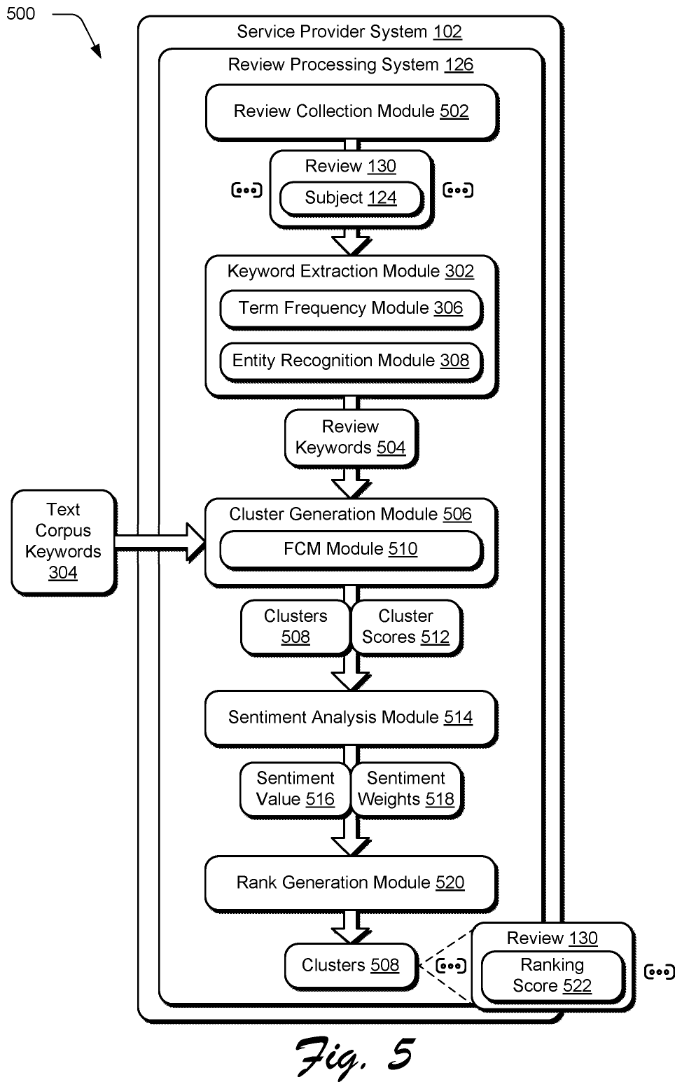

FIG. 2 depicts an example of output of digital content 112 in a user interface 118 of a computing device 104 of FIG. 1. FIG. 3 depicts an example system 300 showing operation of the text corpus processing system 132 of FIG. 1 in greater detail as performing text corpus keyword generation. FIG. 4 depicts a procedure 400 in an example implementation in which a text corpus is generated from digital content 112 and used to extract text corpus keywords that are to serve as a basis to generate clusters to process reviews.

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-4.

To begin in this example, a text corpus processing system 132 collects relevant information regarding the subject 124 of digital content 112. To do so, a keyword extraction module 302 is used to extract text included as part of the digital 112 content to generate a text corpus 122 (block 402). The text corpus processing system 132, for instance, receives digital content 112 from a digital content manager module 110, e.g., from a storage device 114 used to maintain the digital content 112. As previously described, the digital content 112 may take a variety of forms.

In the example 200 of FIG. 2, the digital content 112 is illustrated as stored in a storage device 202 and rendered in a user interface 118. The digital content 112 is configured as a webpage that includes a listing for a good that is available for purchase. The purchase is initiated through user selection of an option illustrated as a “buy” button 204. Therefore, in this example the subject 124 of the digital content 112 is the good available for purchase, e.g., the “Dog Kennel.”

The digital content 112 includes a product description 206 that provides information about the good being offered via the digital content 112. Therefore, to capture an essence of the subject 124, the text corpus processing system 132 first extracts a text corpus 122 from the digital content, e.g., by extracting the “raw text” included as part of the digital content 112. In an instance in which the digital content is a webpage 124, this includes extracting text incorporated as part of the markup language for rendering in the user interface 118. Other examples are also contemplated, such as to extract text from a digital document, through use of optical character recognition, speech-to-text conversion of audio data, and so forth.

Text corpus keywords 304 are then extracted from the text corpus 122 (block 404) by a keyword extraction module 302 of the text corpus processing system 132. A variety of techniques are usable to extract keywords, examples of which are represented by a term frequency module 306 that is configured to determine term frequency of text within the text corpus 122 (block 406) and an entity recognition module 308 that is configured to recognize entities described in the text corpus 122 (block 408).

The term frequency module 306 is configured to determine a number of times a particular item of text (e.g., word) appears in the text corpus 122. In an implementation, this is performed by first filtering out stop words, words describing an entity, pronouns, symbols, and so forth. An output of the term frequency module 306 is configured to describe term frequency in a variety of ways, such as to describe a number of times a corresponding word appears in the text corpus 122, a proportional amount included with respect to an amount of text in the text corpus 122 as a whole, a ranked order, and so forth.

The entity recognition module 308 is representative of functionality to perform entity extraction, which is a natural language processing technique that classifies named entities that are present in the text corpus 122 into predefined categories, e.g., individuals, companies, places, organization, cities, dates, product terminologies, and so forth. As a result, entity recognition as employed by the entity recognition module 308 supports an ability to understand the subject 124 of the text corpus 122. This may be performed by accessing a variety of open-sourced libraries via the network 108 to detect entities from any text corpus 122.

Therefore, the entities recognized by the entity recognition module 308 are included as part of the text corpus keywords 304, and may also do so based on term frequency as performed by the term frequency module 306, through inclusion when a number of over a defined threshold (e.g., specified number, proportion, etc.), and so forth. For example, for a portion of a text corpus that includes “Triple Camera with 25 MP Low Light Lens, 8 MP Ultra-wide Lens, 5 MP Live Focus (Bokeh) Lens” the entities are “Camera,” “Low Light Lens,” “Ultra-wide Lens,” and “Live Focus (Bokeh) lens.” Indications may also be included to indicate a type of entity, e.g., consumer good, work of art, person, place, and so forth. Thus, entity recognition supports insight into brand names, features, specifications, comparable products, and so on. The text corpus keywords 304 are then output by the text corpus processing system 132 (block 410) to serve as a basis for processing the reviews 130, further discussion of which is included in the following section.

Review Processing System

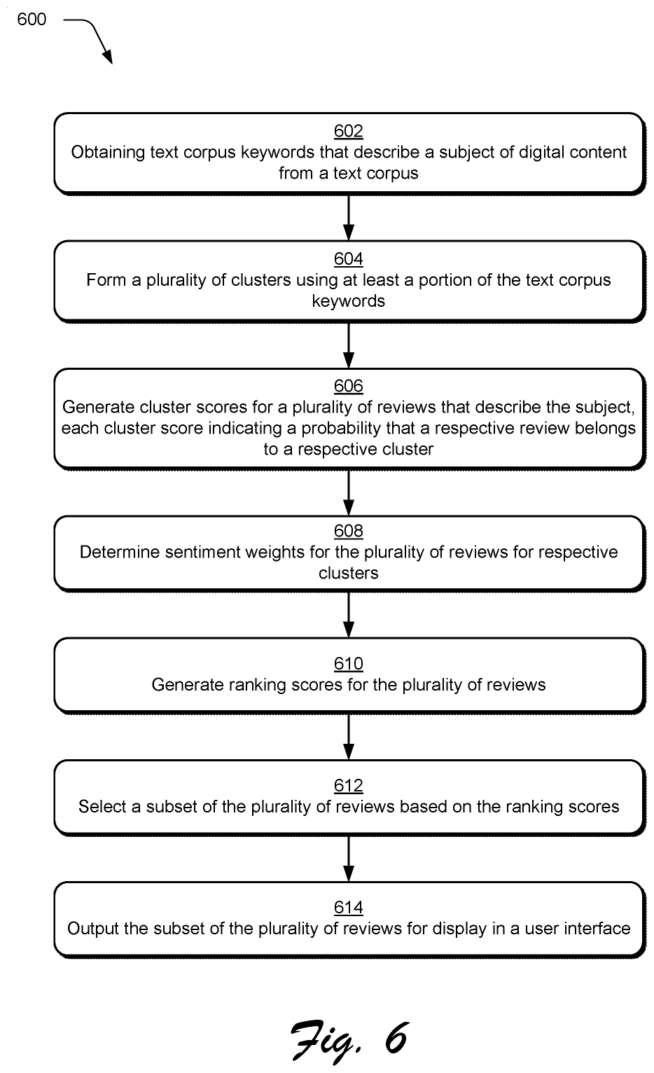

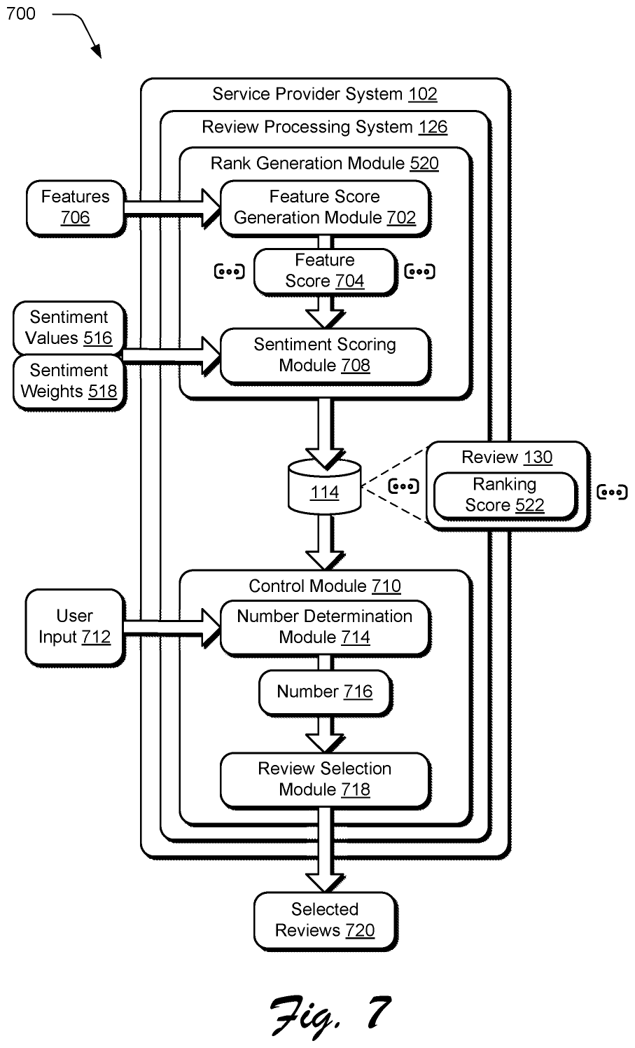

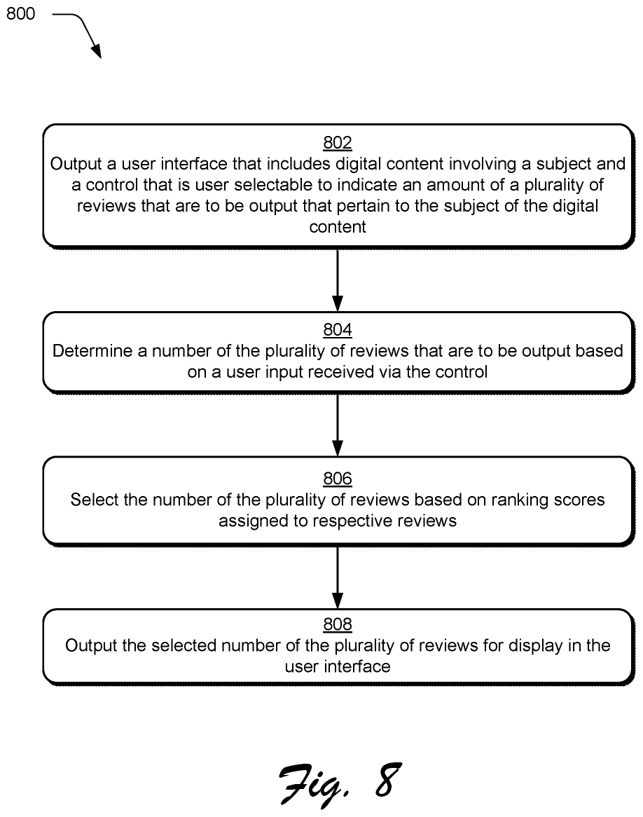

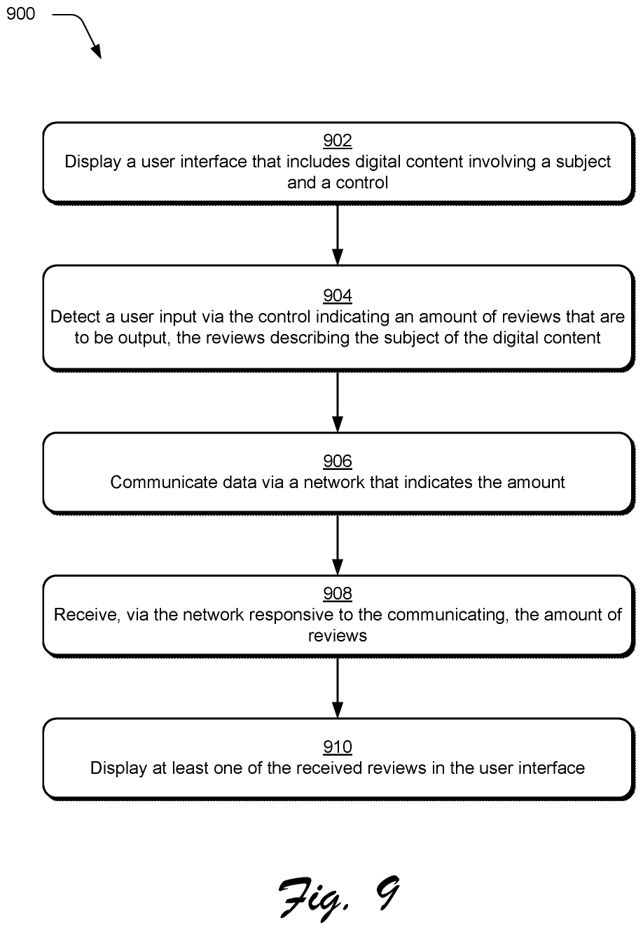

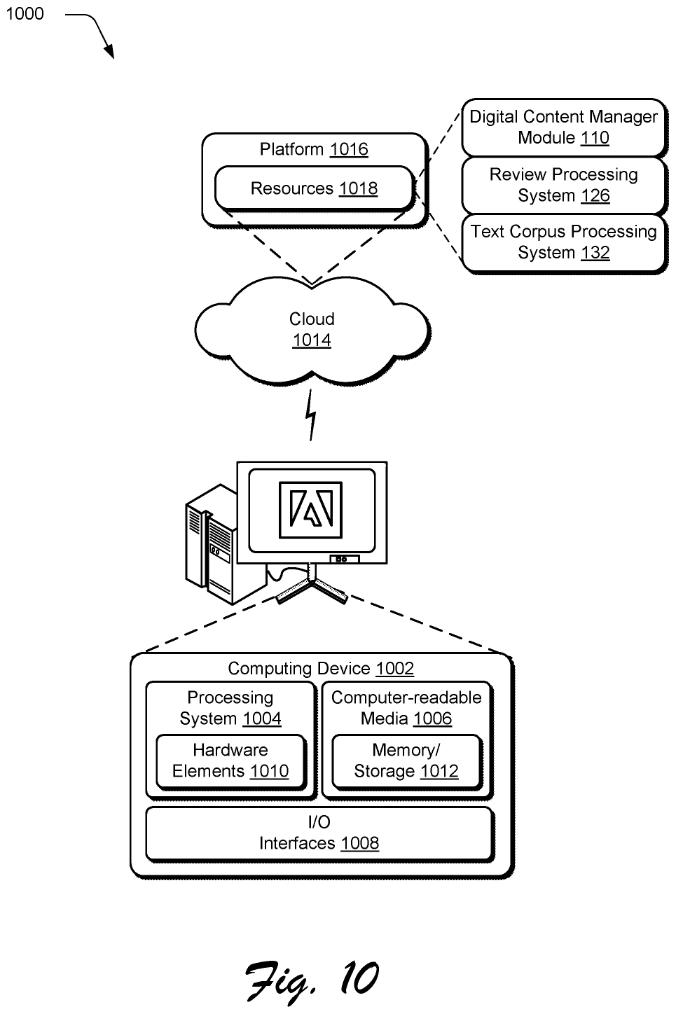

FIG. 5 depicts an example system 500 showing operation of the review processing system 126 of FIG. 2 in greater detail. FIG. 6 depicts a procedure 600 in an example implementation in which text corpus keywords 304 are used to generate clusters that are then used to organize reviews 130 based on cluster membership and sentiment. FIG. 7 depicts an example system 700 showing ranking of reviews 130 and use of a control 134 to control output of a number of the reviews 130. FIG. 8 depicts a procedure 800 in an example implementation in which a determination is made as to a number of reviews based on user interaction with a control 134, which are selected and output for viewing in a user interface. FIG. 9 depicts a procedure 900 in an example implementation of display of a user interface, detection of an input, and output of a number of reviews based on the input.

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 2 and 5-9.

The review processing system 126 is configured to collect and manage dissemination of reviews 130, automatically and without user intervention. To begin, a review collection module 502 is configured to collect reviews 130 pertaining to the subject 124. In one example, the review collection module 502 communicates via the network 108 with client devices 106 that have interacted with the digital content 112, and more particularly a subject 124 of the digital content 112 and in response receives the reviews 130. In another example, a user interface is output by the review collection module 502 that is configured to accept user inputs via the network 108 to generate the review. Collection of the reviews 130 may include verification, e.g., to determine that the user of the client device 106 that is supplying the review 130 has interacted with the digital content 112 or has an account with the service provider system 102. A variety of other examples are also contemplated.

The keyword extraction module 302 is then employed to extract review keywords 504 from the reviews 130. The keyword extraction module 302, in the illustrated example, employs the term frequency module 306 and/or the entity recognition module 308 as previously described above for the text corpus keywords 304 to filter and analyze the reviews 130. As a result, the review keywords 504 provide insight into what is expressed in the respective reviews 130 in a manner similar to that used to gain insight from the text corpus 122.

Text corpus keywords 304 are then obtained by a cluster generation module 506 that describe a subject 124 of digital content from a text corpus 122 (block 602). From this, a plurality of clusters 508 are formed by the cluster generation module 506 using at least a portion of the text corpus keywords 304 (block 604). A variety of techniques are usable to generate the clusters 508, such as to use a predefined number (e.g., set amount, proportional/percentage amount) of the text corpus keywords 304 extracted from the text corpus. This may be performed following linguistic analysis such that similar text corpus keywords are represented with a single respective keyword, i.e., are mapped to a single word.

One example of this is illustrated as a FCM module 510 representing use of a fuzzy c-means clustering technique. Fuzzy clustering is also referred to as soft clustering, in which each element has a probability of belonging to each cluster. In fuzzy clustering, points close to the center of a cluster have a greater probability of belonging to the cluster than points at the edge of the cluster. The degree, to which, an element belongs to a given cluster (e.g., it's probability) is represented as a numerical value, e.g., from 0 to 1. In a fuzzy c-means (FCM) technique, a centroid of a cluster is calculated as a mean of each of the points that belong to the cluster. This centroid is then used to define membership of the reviews 130 to respective clusters, e.g., have at least a threshold probability amount of belonging to the cluster.

The cluster generation module 506, for instance, selects a portion of the text corpus keywords 304 based on a threshold, e.g., a top “X” percentage, a predefined number, and so on to define the clusters 508. Cluster scores 512 are generated for a plurality of reviews that describe the subject 124. Each cluster score 512 indicates a probability that a respective review 130 belongs to a respective cluster 508 (block 606). Review keywords 504 for the respective reviews 130, for instance, are used to calculate a distance of the review keywords 504 to the centroids of the clusters 508 as defined above. Cluster scores 512 based on these distances for the reviews 130 with respect to each of the clusters to define “how much” the reviews 130 belong to the clusters 508, respectively.

The review processing system 126 is also configured to perform sentiment analysis of the reviews 130, functionality of which is represented by a sentiment analysis module 514. The sentiment analysis module 514 implements natural language understanding to determine a sentiment expressed by the respective review 130 toward a particular cluster 508, e.g., the text corpus keyword 304 that defines the cluster. A variety of types of sentiments may be determined, such as positive, neutral, or negative sentiments. The review 130, for instance, includes text stating “the camera on this phone is terrible” and therefore for a cluster formed for the word “camera” the sentiment analysis module 514 determines a sentiment value 516 of “negative” for that review 130 with respect to that cluster 508. Other sentiment types and values are also contemplated, such as a numerical value indicating an amount exhibited between two alternatives, e.g., happy and sad, disinterested and interested, and so forth.

Sentiment weights 518 are also determined by the sentiment analysis module 514 for the plurality of reviews 130 for respective clusters 508 (block 608). Continuing with the previous example, sentiment values 516 describe a sentiment exhibited by respective reviews 130 toward a defining term of a cluster 508, i.e., the text corpus keyword 304 defining the cluster 508. Amounts of the reviews 130 that describe a particular sentiment toward this term are then used to define sentiment weights 518 for reviews 130 that exhibit those sentiments. In other words, the sentiment weights 518 are defined in this example based on a proportion of the reviews 130 assigned to a respective cluster 508 that exhibit a type of sentiment.

For example, consider a scenario having 2671 total reviews, of which a “camera” cluster includes 752 reviews. Of the reviews assigned to the camera cluster, 413 of the reviews exhibit a positive sentiment, 206 a negative sentiment, and 133 a neutral sentiment. Each of positive reviews are multiplied by a sentiment weight of 413/2617 (0.154), negative reviews by a sentiment weight of 206/2671 (0.077), and neutral reviews by a sentiment weight of 133/2671 (0.049). Other examples are also contemplated, such as a scenario defined per cluster. For example, in a positive, neutral, and negative example in which 80% of the reviews 130 assigned to a cluster 508 are positive, 15% of the reviews 130 are neutral, and 5% are negative the sentiment weights 518 for positive, neutral, and negative reviews are 0.8, 0.15, and 0.05, respectively, for the cluster values within that cluster 508.

Therefore, each of the clusters 508 in these examples has stacks/partitions of types of sentiments exhibited within the clusters 508 by the reviews 130. In this way, the sentiment weights 518 ensure that the respective reviews 130 reflect an overall sense of the sentiment of the reviews for a particular cluster 508.

Digital content 112 having a subject 124 of “dog kennel” as illustrated for FIG. 2, includes a product description 206 detailing characteristics of the subject 124. The text of the product description is extracted to form a text corpus 122, which is then processed by a keyword extraction module 302 to extract text corpus keywords 304, e.g., based on text frequency, entity recognition, and so on. A portion of these keywords are then used to define clusters 508, with similar keywords mapped to a same root. For instance, “price,” “cost,” and “bill” are mapped to a single root, “price.” Cluster scores 512 are then generated which describe a probability that the reviews 130 correspond to respective clusters 508. In an implementation, the cluster scores 512 are also aggregated, e.g., based on presence of the review 130 in a number of clusters proportional to a total number of the clusters 508.

The reviews 130 (e.g., comments) are also analyzed using natural language processing by the sentiment analysis module 514 to assign the reviews to respective partitions within the clusters 508, e.g., based on type and magnitude of sentiment expressed with respect to the cluster 508. The sentiment analysis is calculated to measure of relative score of the review 130 based on a total number of reviews included in the cluster 508 and relative to a proportion of the reviews 130 that exhibit similar types of sentiments, e.g., positive, neutral, negative, etc.

A rank generation module 520 is then employed by the review processing system 126 to generate ranking scores 522 for the reviews 130 based at least in part of the cluster scores 508 and the sentiment weights 518 (block 610). The clusters 508, cluster scores 512, sentiment values 516, and sentiment weights 518, for instance, are passed as an input to the rank generation module 520.

A variety of techniques are employable by the rank generation module 520 to generate the ranking scores 522. As shown in FIG. 7, the rank generation module 520 includes a feature score generation module 702 to generate feature scores 704 for the reviews 130. The feature scores 704, in one example, incorporate the cluster scores 512 (which may be aggregated) as previously described along with additional features that have been found in practice to promote accuracy in generation of the ranking scores.

A variety of features 706 are usable by the feature score generation module 702 to generate the feature scores 704. In one example, the feature score 704 is based on a presence and number of review keywords 504 extracted from the reviews 130 that correspond to text corpus keywords 304 extracted from the text corpus 122. This is definable as a ratio based on a number of clusters 508, for which, a respective review 130 belongs (e.g., has over a threshold defined probability of belonging to that cluster 508) divided by a total number of clusters 508.

The features 706 also include a time (e.g., date) at which the review 130 is generated, which is calculated as a difference between a current date and a date associated with metadata of the review. The review 130 having the least difference is given a weight of one and other differences are reduced accordingly, e.g., difference of review time and current time divided by the lowest difference. The features 706 also include a presence and number of digital images included in the review 130, e.g., as a weight defined by a number of digital images. Other examples of features 706 include whether the reviews 130 have upvotes/likes/comments (e.g., with a weight based on a number of upvotes divided by a total number of upvotes for all reviews), whether a user that is associated with the review is verified (e.g., verified interaction with the digital content 112 and/or verified user of the service provider system 102), and so on.

The features scores 704 are then passed to a sentiment score module 708 for weighting in order to generate the ranking score 522. The sentiment values 516 assigned to each of the reviews 130 for a particular cluster 508, for instance, are used to determine an appropriate sentiment weight 518 to be applied to a cluster score 512 directly and/or applied to a feature score 704 that incorporates the cluster score 512. The ranking scores 522 are then associated with the reviews 130, illustrated as maintained in a storage device 114, for use in controlling which subset of the plurality of reviews 130 are selected (block 612) and then output for display in a user interface (block 614), e.g., by a control module 710 for communication over the network 108 for display in the user interface 118 of the computing device 104.

The control module 710 supports a variety of different techniques to control dissemination of the reviews 130 over the network 108. From a viewpoint of the service provider system 102, a user interface is output for communication via the network 108 that includes digital content 112 involving a subject 124 and a control 134 that is user selectable to indicate an amount of a plurality of reviews that are to be output that pertain to the subject of the digital content (block 802) in the user interface. An example of the user interface output by the service provider system 102 is illustrated as being rendered by the computing device 104 of FIG. 2. The user interface 118 includes text indicating a subject of the digital content 112 (e.g., “dog kennel”), a digital image of the subject, and a product description 206 that provides information about the good being offered via the digital content 112.

The user interface 118 also includes a control 134, illustrated as a slider, that supports user interaction to indicate a relative amount of reviews 130 that are desired to be output. The user of the computing device 104, for instance, may have a limited amount of time to view the reviews 130 and specify a lesser amount. In another instance, the user has a significant amount of time and/or a high degree of interest in the subject 124, and therefore interacts with the control 134 to specify a greater number of reviews 130. Data describing this selection is communicated by the communication module 116 over the network 108 back to the service provider system 102.

Upon receipt of this data describing the user input 712, a determination is made by a number determination module 714 as to a number 716 of the plurality of reviews 130 that are to be output based on the user input received via the control 134 (block 804). This number 716 is determined, for instance, as a proportion of the overall reviews, a threshold number of reviews above a threshold ranking score set by the user input 712, and so on based on the user input 712. The number 716 may also be directly specified by the user input 712, such as in a scenario in which a user manually enters the number via the control 134.

The number 716 of the plurality of reviews is selected by a review selection module 718 based on the ranking scores 522 assigned to respective reviews 130 (block 806), which are then output for display in the user interface (block 808) as the selected reviews 720. Continuing with the example above, the number 716 may indicate a single review is to be selected, and therefore the review 130 having the highest ranking score 522 is output as the selected review 720. This may continue as the user input 217 is received to select more or less reviews for output to the computing device 104 via the network 108. In another example, the review selection module 718 selects reviews based on sentiments exhibited by the reviews, e.g., overall proportions. A variety of other examples are also contemplated.

From a perspective of the computing device 104, a user interface 118 is displayed by the display device 120 that includes digital content 112 involving a subject 124 and a control 134 (block 902). A user input is detected via the control 134 indicating an amount of reviews 130 that are to be output, the reviews 130 describing the subject 124 of the digital content 112 (block 904). Data is communicated by the communication module 116 of the computing device 104 via a network 108 that indicates the amount (block 906). The amount of reviews are then received (e.g., the selected reviews 72) via the network 108 responsive to the communicating of the data (block 908) and at least one of the received reviews are then displayed in the user interface 118 (block 910). A variety of other examples are also contemplated. In this way, the techniques described herein overcome the challenges of conventional techniques and improve efficiency in both navigation and computational resource consumption.

Example System and Device

FIG. 10 illustrates an example system generally at 1000 that includes an example computing device 1002 that is representative of one or more computing systems and/or devices that may implement the various techniques described herein. This is illustrated through inclusion of a digital content manager module 110, a review processing system 126, and a text corpus processing system 132 of FIG. 1. The computing device 1002 may be, for example, a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interface 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1006 is illustrated as including memory/storage 1012. The memory/storage 1012 represents memory/storage capacity associated with one or more computer-readable media. The memory/storage component 1012 may include volatile media (such as random access memory (RAM)) and/or nonvolatile media (such as read only memory (ROM), Flash memory, optical disks, magnetic disks, and so forth). The memory/storage component 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of a module that is executable by the computing device 1002 as software may be achieved at least partially in hardware, e.g., through use of computer-readable storage media and/or hardware elements 1010 of the processing system 1004. The instructions and/or functions may be executable/operable by one or more articles of manufacture (for example, one or more computing devices 1002 and/or processing systems 1004) to implement techniques, modules, and examples described herein.

The techniques described herein may be supported by various configurations of the computing device 1002 and are not limited to the specific examples of the techniques described herein. This functionality may also be implemented all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 may include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 may abstract resources and functions to connect the computing device 1002 with other computing devices. The platform 1016 may also serve to abstract scaling of resources to provide a corresponding level of scale to encountered demand for the resources 1018 that are implemented via the platform 1016. Accordingly, in an interconnected device embodiment, implementation of functionality described herein may be distributed throughout the system 1000. For example, the functionality may be implemented in part on the computing device 1002 as well as via the platform 1016 that abstracts the functionality of the cloud 1014.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium text processing environment, a method implemented by a computing device, the method comprising:
extracting, by the computing device, text corpus keywords that describe a subject of digital content from a text corpus;
forming, by the computing device, a plurality of clusters using at least a portion of the text corpus keywords;
generating, by the computing device, cluster scores for a plurality of reviews that describe the subject, each said cluster score indicating a probability that a respective said review belongs to a respective said cluster;
determining, by the computing device, sentiment weights for the plurality of reviews for respective said clusters;
generating, by the computing device, ranking scores for the plurality of reviews based at least in part on the cluster scores and the sentiment weights;
selecting, by the computing device, a subset of the plurality of reviews based on the ranking scores; and
outputting, by the computing device, the subset of the plurality of reviews for display in a user interface.

2. The method as described in claim 1, further comprising extracting, by the computing device, review keywords from the plurality of reviews that describe the subject and wherein the generating of the cluster scores is based at least in part on a comparison of the review keywords with text corpus keywords used to define the respective said clusters.

3. The method as described in claim 1, wherein the determining of the text corpus keywords is based on term frequency or entity recognition of text within the text corpus.

4. The method as described in claim 1, wherein the generating of the plurality of clusters is performed using a fuzzy c-means (FCM) technique.

5. The method as described in claim 1, wherein each cluster of the plurality of clusters corresponds to a respective text corpus keyword from the plurality of text corpus keywords.

6. The method as described in claim 1, further comprising identifying a subset of the plurality of text corpus keywords using a threshold value, and wherein the plurality of clusters correspond to respective text corpus keywords from the subset.

7. The method as described in claim 1, wherein the sentiment weights correspond to a type of sentiment and amount of the sentiment that is expressed within the respective said cluster.

8. The method as described in claim 7, wherein the type of sentiment indicates at least one of a positive, negative or neutral sentiment associated with the respective said cluster.

9. The method as described in claim 1, wherein the selecting of the subset is based on a user input received the user interface, the user input usable to determine a number of the plurality of reviews that are to be output.

10. The method as described in claim 9, wherein the user input is received using a slider control.

11. The method as described in claim 1, further comprising receiving an input identifying the subject and wherein the extracting, generating of the plurality of cluster values, the generating the sentiment values, the ranking, the selecting, and the outputting are performed automatically and without user intervention by the computing device responsive to the input.

12. In a digital medium text processing environment, a system comprising:
a processing system; and
a computer-readable storage medium having instructions stored thereon that, responsive to execution by the processing system, causes the processing system to perform operations including:
outputting a user interface that includes digital content involving a subject and a control that is user selectable to indicate an amount of a plurality of reviews that are to be output that pertain to the subject of the digital content;
determining a number of the plurality of reviews that are to be output based on a user input received via the control;
selecting the number of the plurality of reviews based on ranking scores assigned to respective said reviews; and
outputting the selected number of the plurality of reviews for display in the user interface.

13. The system as described in claim 12, wherein the ranking scores are generated based on:
cluster scores indicating a probability that a respective said review belongs to a respective cluster of a plurality of clusters, the plurality of clusters generated based on keywords extracted from the digital content; and
sentiment weights for the plurality of reviews, the sentiment weights correspond to a type of sentiment and amount of the sentiment that is expressed within the respective said cluster.

14. The system as described in claim 12, wherein the control is a slider.

15. The system as described in claim 12, wherein the plurality of reviews are reviews submitted by a plurality of client devices regarding the subject of the digital content.

16. The system as described in claim 15, wherein the subject is a good or service and the plurality of reviews are user-generated reviews of the good or service.

17. In a digital medium text processing environment, a method implemented by a computing device, the method comprising:
displaying, by the computing device, a user interface that includes digital content involving a subject and a control;
detecting, by the computing device, a user input via the control indicating an amount of reviews that are to be output, the reviews describing the subject of the digital content;
communicating, by the computing device, data via a network that indicates the amount;
receiving, by the computing device via the network responsive to the communicating, the amount of reviews; and
displaying, by the computing device, at least one of the received reviews in the user interface.

18. The method as described in claim 17, wherein the amount of reviews are selected using ranking scores, the ranking scores generated based on:
cluster scores indicating a probability that a respective said review belongs to a respective cluster of a plurality of clusters, the plurality of clusters generated based on keywords extracted from the digital content; and
sentiment weights for the plurality of reviews, the sentiment weights correspond to a type of sentiment and amount of the sentiment that is expressed within the respective said cluster.

19. The method as described in claim 17, wherein the control is a slider.

20. The method as described in claim 17, wherein the plurality of reviews are reviews submitted by a plurality of client devices regarding the subject of the digital content.
